(19) United States
(12) Patent Application Publication
(10) Pub. No.: US 2018/0231668 A1
(43) Pub. Date: Aug. 16, 2018

(54) Dynamic Anchor Network for a First Responder Situation

(71) Applicant: Honeywell International Inc., Morris Plains, NJ (US)

(72) Inventors: Zero XIA, Shanghai (CN); Jennifer SHEN, Shanghai (CN); Wayne ZHANG, Shanghai (CN); Vicky GUO, Shanghai (CN); Clark SHAO, Shanghai (CN)

(73) Assignee: Honeywell International Inc., Morris Plains, NJ (US)

(21) Appl. No.: 15/751,696

(22) PCT Filed: Aug. 10, 2015
(86) PCT No.: PCT/CN2015/086477

§ 371 Date: Feb. 9, 2018

(51) Int. Cl. G01S 19/46; G01S 19/07; G01S 5/08; G01S 19/51; G01S 19/40

(52) U.S. Cl. CPC G01S 19/46; G01S 19/07; G01S 19/40; G01S 19/51; G01S 5/08

(57) ABSTRACT

A method for establishing a location anchor network includes receiving, by a location application executing on a processor, GPS positions from each of the plurality of location anchors, determining, by the location application, a preliminary network topology using the GPS positions for each of the plurality of location anchors, receiving, by the location application, an inter-location anchor spacing between the plurality of location anchors, determining, by the location application, a final network topology based on the GPS position and the inter-anchor spacing, and storing the final network topology in a memory. The plurality of location anchors are portable, and the plurality of location anchors are deployed at a location associated with a structure. The final network topology defines a position estimate for each location anchor of the plurality of location anchors.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A number of person and asset location tracking technologies have been developed and are emerging in the market space (e.g. GPS systems, cell phone tracking, building asset tracking). The asset tracking systems may not be accurate, which is not needed in all instances. For example, tracking an asset within a warehouse only need to be accurate to within tens of yards in order to allow a worker to locate an item. In some cases, GPS location estimates can be used. However, GPS location estimates may not be available indoor where the GPS signal is not available, and therefore the use of GPS technology may not be suitable in all instances.

### SUMMARY

In an embodiment, a method for establishing a location anchor network comprises receiving, by a location application executing on a processor, GPS positions from each of the plurality of location anchors, determining, by the location application, a preliminary network topology using the GPS positions for each of the plurality of location anchors, receiving, by the location application, an inter-location anchor spacing between the plurality of location anchors, determining, by the location application, a final network topology based on the GPS position and the inter-anchor spacing, and storing the final network topology in a memory. The plurality of location anchors are portable, and the plurality of location anchors are deployed at a location associated with a structure. The final network topology defines a position estimate for each location anchor of the plurality of location anchors.

In an embodiment, a method of determining a location of a tag comprises determining a location network topology of a plurality of location anchors deployed in a structure, receiving, by a tracking application executing on a processor, a plurality of distance measurements between a tag and the plurality of location anchors, determining, by the tracking application, a position of the tag relative to the plurality of location anchors, comparing, by the tracking application, the position of the tag with the location network topology of the plurality of location anchors in a structure, and determining a position of the tag within the structure based on the comparing. Determining the location network topology is based on both GPS position estimates of the plurality of location anchors and Real Time Location System ranging estimates of inter-location anchors spacings between the plurality of location anchors.

In an embodiment, a location determination system comprises a plurality of location anchors, at least one tag moveably disposed within the perimeter, and a base station in signal communication with the plurality of location anchors and the at least one tag. The plurality of location anchors each comprise a GPS receiver, and Real Time Location System (RTLS) ranging system, and the plurality of location anchors are deployed in a network associated with a structure. The base station comprises a memory and a processor, and an application is stored in the memory configures the processor to: receive GPS positions from each of the plurality of location anchors, receive inter-anchor spacings between at least two of the plurality of location anchors using the RTLS ranging system, determine a relative position of each location anchor of the plurality of location anchors based on the GPS position, correct the relative position of each location anchor using the inter-anchor spacings, determine a location network topology of the plurality of location anchors based on the correcting, determine a distance between the tag and at least two location anchors of the plurality of location anchors, and determine a position of the tag within the location network topology based on the distances between the tag and the at least two location anchors of the plurality of anchors.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 schematically illustrates a structure having a location anchor network according to an embodiment.

FIG. 2 schematically illustrates another structure having a location anchor network according to an embodiment.

FIG. 3 illustrates a flowchart of a method of establishing a dynamic location anchor network according to an embodiment.

FIG. 4 illustrates a flowchart of a method of tracking a tag within a dynamic location anchor network according to an embodiment.

FIG. 5 illustrates an embodiment of a computer system that can be used with the embodiments described herein.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Disclosed herein is a dynamic location anchor system that can automatically establish a network topology in an emergency situation. The dynamic system can include portable location anchors that can be deployed within a structure when needed. The location anchors can include at least two locating technologies include GPS and distance ranging. Once deployed in or around a structure such as a building, house, high-rise, or the like, the location anchors may be activated and begin to determine their position using the GPS receivers.

The resulting GPS position determination may provide an initial indication of the arrangement of the location anchors, where the accuracy of the GPS position estimates may place the location anchors within several yards of their actual position. In order to improve upon the location determinations, the location anchors may also include ranging sensors. The ranging sensors can include ranging based on time of flight measurements of signals between the location anchors. The ranging sensors can be used to establish the inter-location anchor distances between the location anchors. These measurements may be used to establish the relative distances between the anchors with relatively high precision, which can be less than one foot in some instances. These distances can be used to reduce the relative errors in the GPS position estimates to provide an overall location anchor topology. The various location determinations can be performed, in some instances, on a base station in signal communication with the location anchors.

In some embodiments, the height of the location anchors may be desirable in order to identify a floor on which the location anchors are deployed. In order to provide the height information, one or more location anchors can be deployed at ground level to allow the vertical position of the location anchors to be determined. These vertical location anchors may serve to calculate a height of the location anchors, which can be used along with estimates of the floor heights to determine the floor on which the location anchors and/or a person wearing a tag is located.

The ability to quickly deploy and activate the location anchors may allow the system to self-locate and determine a topology for use in tracking a person within the structure. The resulting system can then be used to track a person within the structure. The person may wear a tag that can communicate with the location anchors. The tag may use a ranging system to determine the distance between the tag and a plurality of the location anchors. This information can then be used to determine the tag's position within the structure. The various information determined by the system can be mapped and displayed to provide a near real time information system for tracking emergency responders in an emergency situation. This system advantageously does not require the presence of location anchors prior to deploying the portable location anchors and the system can be set up and activated in a short period of time.

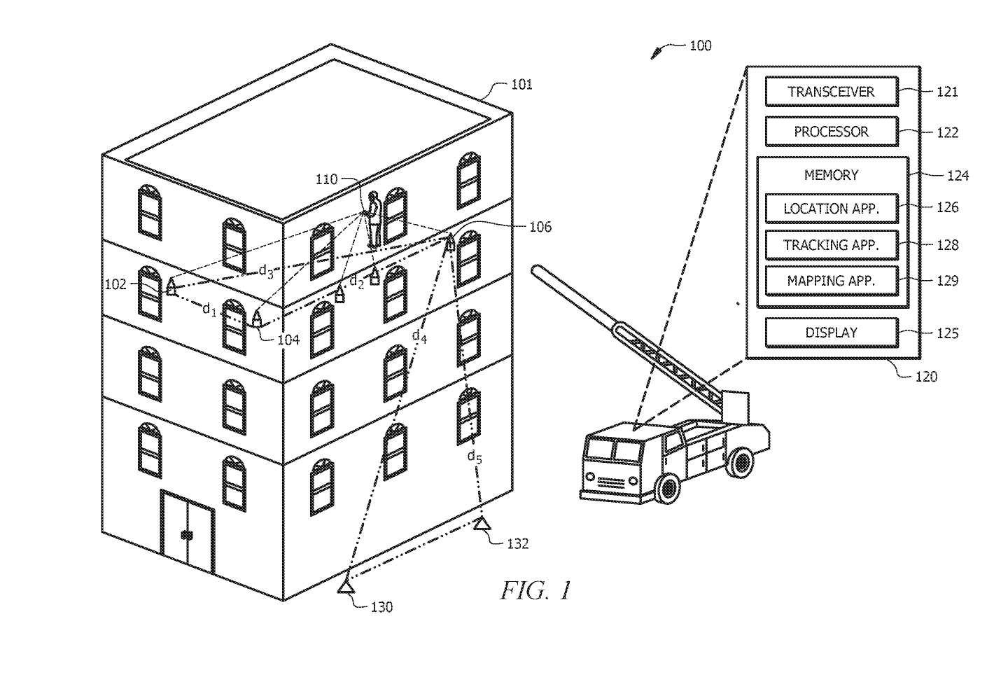

FIG. 1 schematically illustrates a system 100 for establishing a dynamic anchor network and detecting the location of an asset having a transceiver in a tag 110 within the anchor network. The system 100 can comprise a plurality of location anchors 102, 104, 106 that can be deployed around a structure 101. The location anchors 102, 104, 106 can communicate with a base station 120 to allow for the location network to be established based on readings from the location anchors 102, 104, 106. Once a location network has been determined, a tag 110 deployed within the location network can be tracked to provide a location of the transceiver, for example, in an emergency response situation.

The plurality of location anchors 102, 104, 106 can comprise portable devices that can be transported to the structure 101 and placed in their respective positions for use during an emergency. The location anchors can comprise standalone devices that comprise a processor, memory, and a transceiver for sending and receiving wireless signals. In an embodiment, the location anchors 102, 104, 106 can be used to dynamically establish a location network at a site and provide information regarding the time, location of the location anchor, and distance information between each location anchor to the base station 120 for processing.

Each location anchor 102, 104, 106 can communicate with one or more of the other location anchors deployed at various locations in the structure 101 using wireless communications. Since the location anchors may be deployed in the absence of an established wireless network, each location anchor can contain a wireless communication device to allow for a dynamic wireless network to be established quickly and efficiently in the event of an emergency. The wireless communication transceivers can be integrated into the location anchors to allow for communication between the location anchors 102, 104, 106 and the base station 120. In an embodiment, each of the location anchors 102, 104, 106 may communicate with the base station 120.

In some embodiments, less than all of the location anchors may be in communication with the base station 120. In these embodiments, a mesh connection between the location anchors 102, 104, 106 can be used to pass communications between the location anchors, and a location anchor in communication with the base station 120 can then be used to transfer the information from the location anchors to the base station 120. Various wireless communication protocols such as Wi-Fi, Bluetooth, communication using the IEEE 802.15.4 standard (e.g., a ZigBee device network), and the like can be used to provide a communication network to allow the location anchors to communicate information to the base station 120. The use of a mesh network may allow for the deployment of the location anchors across a large area of the structure 101 while still allowing the location anchors to communicate with the base station 120.

In addition to acting as a potential access point for other location anchors, one or more of the location anchors may also serve as an access point for the tag 110 for example, by providing an IEEE 802.11 access point service. When acting as an access point, the location anchor may provide service as a component of the network to relay information, for example, location information from the tag 110 to a location module 126, as described in more detail herein.

In order to allow the location anchors to be portable, each location anchor may be provided with power via a rechargeable battery and/or a disposable battery, depending upon design considerations and goals. The location anchors may also comprise a processor and a memory to store a start-up process to establish communications with additional location anchors and/or the base station 120.

While only three location anchors 102, 104, 106 are labeled, the system 100 can comprise any number of location anchors. It will be appreciated that based on the limiting communication range of each location anchor, a suitable number of location anchors may be needed to allow the position of the transceiver to be determined.

The location anchors 102, 104, 106 can be deployed to dynamically establish a location network that provides the ability to identify and track a tag 110 within the network. In order to establish the location network, the location anchors comprise a plurality of location technologies. Once the location network is established, the position of the tag 110 can be tracked within the location network and reported back to the base station 120.

In an embodiment, the location anchors 102, 104, 106 can comprise a Global Positioning System (GPS) receiver and a ranging system. The GPS system generally relies upon a line of site communication with one or more satellites to determine a geographic location. The GPS reception is known to decrease within a structure, and as a result, the location anchors 102, 104, 106 can be placed on an exterior of the building at the approximate location of the floor of interest. When it is not practical to access the exterior of the building (e.g., for a multi-floor structure), the location anchors 102, 104, 106 can be placed within the structure 101 in a location that allows the location anchors 102, 104, 106 to receive a GPS signal. In an embodiment, the location anchors 102, 104, 106 can be placed on an interior of a window or other structure that allows for the reception of the GPS satellite signals.

The location anchors 102, 104, 106 can be placed on a floor of interest so that the tag 110 is approximately aligned in a plane defined by the plurality of location anchors 102, 104, 106. If a floor cannot be accessed, the location anchors 102, 104, 106 can be placed on a different floor that may be adjacent to the floor where the transceiver is located. For example, when a fire occurs on a floor of a building, the response personnel deploying the location anchors may not be able to access the floor with the fire. In this instance, the location anchors may be placed on the floor below the floor with the fire. As described in more detail herein, the ranging technology can be used to provide ranging information through certain structures including walls, floors, furniture, and the like.

The GPS receiver can then be used to determine a relative geographic position for each of the location anchors 102, 104, 106. Once placed in the structure 101 and activated, the GPS receivers can acquire the satellite signals and process a geographic position of each location anchor 102, 104, 106. A GPS module within each location anchor 102, 104, 106, may receive the GPS satellite signals and provide a geographic position of the respective location anchor. The geographic position can serve as an estimate of the approximate position of each location anchor 102, 104, 105. The geographic positions can be transmitted to the base station 120 for use with the location module 126.

The use of the GPS location estimate can include a relative position error. In order to improve the location network positioning, each location anchor 102, 104, 106 can also comprise a ranging system such as an Real Time Location System (RTLS) that can use Ultra Wide Band (UWB) ranging. RTLS ranging systems generally use a one-way or two-way time of flight measurement between a transmitter and a receiver to determine a distance between the two end points. The RTLS ranging measurements can have a high degree of accuracy down to around 6 inches in some instances.

The RTLS ranging system may be used to determine a distance between each location anchor 102, 104, 106 and one or more of the other location anchors. For example, the RTLS ranging may be used to determine the distance d1, d2, and/or d3. In an embodiment, the RTLS ranging can be used to determine a distance between each location anchor 102, 104, 106 and at least one other location anchor. Additional distance determinations can be used to further improve the accuracy of the location network, but every possible distance determination is not needed for the location network to be determined.

The RTLS ranging determination can use a UWB signal between pairs of the location anchors 102, 104, 106 to determine the distance between the location anchors. The resulting time of flight information can be used to perform a distance determination on a processor of the location anchor, or the information can be transmitted to the base station 120 to perform the distance determinations. The resulting information may provide distance values between the location anchors 102, 104, 106 that can be transmitted to the base station 120 for use with the location module 120.

When the structure 101 has multiple levels, one or more vertical location anchors 130, 132 can be used with the system 100 to provide an indication of the height of the location anchors 102, 104, 106. The use of the location anchors with GPS capabilities may allow for some degree of altitude determination. However, the accuracy of the altitude measurement may not be sufficient for use in an emergency situation, and the altitude measurement generally provides a reference above sea level, which does not provide a direct indication of the height of the location anchors above the ground level of a structure.

A determination of the floor on which the transceiver is located can be provided by deploying the vertical location anchors 130, 132 at ground level to provide distance measurements for the vertical height of the location anchors 102, 104, 106 placed at or near the floor of interest. The vertical location anchors 102, 104, 106 can be the same or similar to the location anchors 102, 104, 106, though the vertical location anchors 130, 132 may not need to have GPS receivers incorporated therein.

While one vertical location anchor 130 may be used, the height measurement may have an associated error if the vertical location anchor 130 is not vertically aligned with one or more of the location anchors 102, 104, 106 used at height. The use of two or more vertical location anchors 130, 132 may allow for two distance measurements d4, d5 to be determined using the RTLS ranging, where the distance measurement(s) can be used to determine the vertical height of at least one location anchor 102, 104, 106.

The distance measurements can be performed on a processor of the vertical location anchors 130, 132, on a processor of the location anchors 102, 104, 106, and/or the information can be transmitted back to the base station 120 and the height of the location anchors 102, 104, 106 can be determined in the base station 120. When the height information is used, a three dimensional location network of the building can be generated including both the horizontal position within the building as well as an indication of the floor of the tag 110.

In addition to the communication components and the location components, the location anchors 102, 104, 106 can also comprise a number of optional sensors. In an embodiment, one or more of the location anchors 102, 104, 106 can comprise temperature sensors, pressure sensors, gas detectors, or the like, which may allow conditions within the location network to be monitored or recorded during an event.

The tag 110 can be associated with a person such as an emergency responder including a fire fighter, a police officer, an emergency medical technician, or the like. The tag can generally comprise a device that is capable of communicating with a plurality of the location anchors 102, 104, 106 to provide a RTLS ranging determination within the location network. In an embodiment, the tag 110 can comprise a transceiver for receiving and sending ranging signals to one or more of the location anchors 102, 104, 106. In some embodiments, the tag 110 may comprise a processor, a memory, a transceiver, and one or more optional sensors.

The tag 110 may generally be portable and carried with an emergency responder. The transceiver in the tag 110 may be capable of communicating with the base station 120 directly or through one or more of the location anchors 102, 104, 106. For example, at least one of the location anchors 102, 104, 106 may have access point functionality, and the tag 110 may be capable of communicating with the base station 120 through the access point functionality provided by the location anchor. The tag 110 may be provided with power via a battery.

Once the location network is established, a tag 110 within the location network can be tracked using the plurality of location anchors 102, 104, 106 to determine two or more distances between two or more of the location anchors 102, 104, 106 and the tag 110. In some embodiments, more than two distance measurements are used to provide improved accuracy in the location determination of the tag within the location network. The distance information between the location anchors 102, 104, 106, and the tag 110 can be processed within the tag 110, one or more of the location anchors 102, 104, 106, and/or at the base station 120.

In some embodiments, the tag 110 may comprise additional functionality. For example, the tag may be part of a bio-harness, gas sensor, portable breathing apparatus, portable radio, or other equipment used by an emergency responder. In addition to the location information, the information sent to the base station 120 may include a tag identifier, a time stamp, and optionally additional information about the environment in which the tag 110 is located. Exemplary information can include biometric parameters (e.g., heart rate, blood pressure, breathing rate, temperature, etc.), ambient temperature, gas sensor information, or any combination thereof. This information may be transmitted to the base station 120 for use in logging the information and/or forming a map or output depicting the situation in the structure 101.

The base station 120 can be in signal communication with one or more of the location anchors 102, 104, 106 to receive information including the location determination information. The base station 120 can comprise a computer having a transceiver 121 providing communication with one or more of the location anchors 102, 104, 106 and/or the tag 110, a processor 122, and a memory 124. The memory 124 can store one or more applications or modules including a location module 126, a tracking module 128, and a mapping module 129. In general, the base station 120 serves to receive information from the location anchors 102, 104, 106 and/or the tag 110 to dynamically determine the location network once the location anchors 102, 104, 106 have been deployed, and use the location network to track the tag 110 within the location network once the location network has been determined.

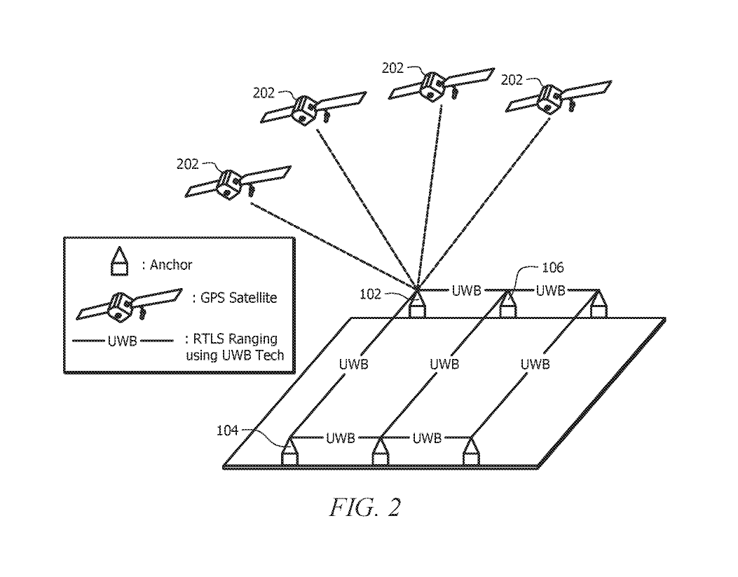

The location application 126 can execute on the processor to configure the processor to determine a location network from information obtained from the one or more location anchors 102, 104, 106. As additionally shown in FIG. 2, the system 100 may be used to dynamically determine a location network and network topology. When the system is to be used, the location anchors can be deployed at the appropriate positions around a structure 101. Each location anchor 102, 104, 106 can acquire a GPS signal from a plurality of GPS satellites 202 and determine a location based on the GPS signal. At the same time, RTLS ranging can be carried out between the location anchors 102, 104, 106 to determine the distance measurements between the location anchors 102, 104, 106 that are deployed. This information can then be sent back to the base station 120 for further processing.

The location application 126 can receive the GPS location estimates and the inter-location anchor distances for further processing. Initially, the location application 126 may use the GPS location estimates to establish a preliminary topology of the location network. The location network can be defined by the location anchor topology that includes the location coordinates of each location anchor in the network and the relative positions of each location anchor with respect to each other as well as the structure 101. The location network determined using the GPS locations can be used with the system as the location network for use in tracking the location of the tag 110.

In some embodiments, the GPS location estimates can be used with the inter-location anchor distances to determine an improved location network position determination for each location anchor 102, 104, 106. The location application 126 can use the inter-location anchor distances to determine the location anchor spacings. The GPS position errors can then be reduced using an error minimization routine. The resulting location network topology may be more accurate than using the GPS location estimates alone.

The location application 126 can also be used to identify a height of the location anchors 102, 104, 106 in the structure 101. The location application 126 may receive information from one or more vertical location anchors 130, 132. The information can include the vertical location anchor identifications, the inter-location distances between the vertical location anchors 130, 132 themselves and the inter-location anchor distances between the vertical location anchors 130, 132 and one or more of the location anchors 102, 104, 106.

The location application 126 may determine the distance between the vertical location anchors and the one or more location anchors 102, 104, 106 to determine the approximate height from the ground to the location anchors 102, 104, 106. The location application 126 can use trilateration when three distances are known or multilateration when a more than three distances between the one or more vertical location anchors and the location anchors are known. The location application 126 may also receive an approximate floor height for the structure 101 to allow the number of floors in the structure between the ground floor and the floor having the location anchors 102, 104, 106 to be determined. Additional inputs may include adjustments for a first floor height spacing that is different than other floor heights, height offsets between the floor where the location anchors 102, 104, 106 are deployed and the floor where the response personnel are located, and the like. The location application 126 may then determine the floor location of the location anchors 102, 104, 106 and/or the floor location of the response personnel associated with the tag 110. For example, the height of the location anchors 102, 104, 106 above the ground can be divided by the average floor height to determine the floor where the location anchors are deployed. Any offsets for the floor where the tag is deployed can then be used to determine the floor location of the tag 110.

The location application 126 may then store the location network information in the memory 124 for use with the tracking application 128. The tracking application 128 may execute on the processor 122 and configure the processor to receive information about the tag 110 within the location network. In an embodiment, the tracking application 128 may receive information from the tag comprising distance information from the tag 110 to a plurality of location anchors 102, 104, 106. Using trilateration, multilateration, and/or other location techniques, the location of the tag 110 within the location network can be determined and logged.

In an embodiment, the tracking application 128 may also receive a tag identification, location anchor identification, and the tag-location anchor distance, and optionally, additional information such as environmental information, biometric information, and/or a timestamp for the location determination. The timestamp can be used to determine a relative position of the tag 110 at a given time. A series of location updates can be tracked to produce a track for the tag 110 within the location network. The track may both identify a current or last known position of the tag 110 within the location network and/or the track may be used to predict a current position of the tag 110 within the location network in the event that communication with the tag 110 is lost during an event. The location information and the track can be stored in the memory 124.

The base station 120 can optionally include a mapping application 129 in the memory 124. The mapping application 129 can generate a display of the structure 101, the floor of interest, the plurality of location anchors 102, 104, 106, and/or the tag 110 within the location network. The mapping application 129 may interact with the location application 126 to obtain the location network topology and the tracking application 128 to obtain the tag 110 location and track information. The information can be combined along with information about the structure 101 to enable a composite display to be generated and output to a display device. The graphical output may allow a tag to be quickly located while directing other emergency response personnel to the tag location.

The display information for the structure 101 can be obtained to allow the structure to be modeled. The structure information can be obtained from an image and a wireframe model can be generated. If floor plan images are available, the images can be loaded into the memory 124 and presented as an overlay aligned with the location network topology. In some embodiments, satellite imagery may be used to align the location network topology with the image for the display. Multiple top or footprint view and side views from the satellite and even from video taken from a vehicle or asset within the structure 101, may be used to construct a wireframe version of the structure for the display. Correlation of the view using one or more distance sensors associated with the base station 120 may be used to align the images. Video from a camera image may be used to further augment the representation of the structure to still further provide a view that is easily understood by the user. In some embodiments, the mapping application 129 may further augment the image of the structure 101 with user observed information, such as the number of floors of the structure. The number of floors can also be obtained from the location application 126 using the vertical location anchor 130, 132 information for the height of the location anchors 102, 104, 106. Such information may also be derived from video images. In still further embodiments, if the floor plan is known, it may also be correlated and augmented with the data obtained from multiple sources.

When the wireframe or other representation of the structure 101 is created by the mapping application 129, the model may be further augmented with information obtained from fire alarm sensors and other sensors within the structure. When the tag 110 comprises additional and optional sensors, the sensor information may be displayed on the model. For example, gas detector information and/or smoke data can be mapped by the mapping application 129 and displayed in the model. When multiple tags are present, each tag can be displayed with an associated identification number. The display 125 associated with the base station 120 can be located with the base station 120. For example, a computer serving as the base station can include a display 125 that can present the map.

In some embodiments, a display can be associated with the tag 110 and/or with a communication device associated with the tag 110. The display may be capable of displaying the map, relative positions, directions, and the like. For example, the map can also be sent to the tag 110 when the tag 110 includes a display or output. The image may be sent through the wireless communication network to the tag to allow a user to view the information while in the structure 101. This may allow the emergency response personnel to locate a tag. For example, a firefighter that experiences trouble can be located by other firefighters in the area.

In some embodiments, the display at the tag 110 and/or with the communication device associated with the tag 110 may display location information in a format other than a map. For example, a relative direction heading or a relative position may be displayed. This may be useful in locating another tag associated with another responder. For example, if a firefighter is injured, the display on the surrounding firefighters' displays may include a relative direction and distance information to allow the other firefighters to quickly located and assist the injured firefighter. Various other information may also be displayed on the display at the tag 110/communication device such as a local condition, a condition at another tag, movement instructions through the structure 101, or the like.

In use, the dynamic location system could first be deployed. The system described herein may be portable and can be used at a location that does not have a pre-existing location anchor network. While only three location anchors 102, 104, 106 are labeled, any number of location anchors can be used to establish the location network topology.

When a situation occurs, one or more responders may be tasked with deploying the plurality of location anchors within the structure to allow the network topology to be dynamically established. The responders can enter the structure and locate positions for the location anchors 102, 104, 106 to be deployed. In some embodiments, all or a portion of the plurality of location anchors 102, 104, 106 can be deployed on the exterior of the structure 101. When the floor of interest is inaccessible, the location anchors 102, 104, 106 can be deployed on a nearby floor. For example, a fire situation may prevent access to a floor that is on fire, and the floor below the fire may be used to deploy the plurality of location anchors 102, 104, 106.

The location anchors 102, 104, 106 may be deployed to form a perimeter around the structure 101. In some embodiments, one or more location anchors may be placed within an interior of the structure 101 so long as the location anchor can receive a GPS signal. Interior location anchors may be useful for larger structures and/or for structures in which the RTLS ranging signals are blocked by interior structures.

Once the location anchors 102, 104, 106 are deployed into a position, they can be activated to perform a start-up procedure. Initially, each location anchors 102, 104, 106 may scan for an initiated the GPS location process. Once the GPS satellite signals are received, a position determination can be made by the location anchors 102, 104, 106. At the same time, or subsequent to, the GPS location determination, each location anchor 102, 104, 106 may begin a RTLS ranging process with one or more of the other location anchors 102, 104, 106. While each location anchor can perform the ranging process with every other location anchor, a complete ranging process may not be needed. Rather, ranging estimates to one, two, or three other location anchors may be sufficient to determine the location network topology. The GPS estimates from each location anchor 102, 104, 106 and the ranging estimates can then be sent to the base station 120 for determination of the location network topology.

When the structure 101 has more than one floor, or in some application, more than a few floors, one or more vertical location anchors 130, 132 can be used to automatically determine a height to the plurality of location anchors. The vertical location anchors 130, 132 can be deployed in a similar manner to the location anchors 102, 104, 106. A response personnel can deploy the vertical location anchors at a ground level below one or more of the plurality of location anchors 102, 104, 106. The vertical location anchors 130, 132 may use a line of sight connection to the plurality of location anchors 102, 104, 106, and the vertical location anchors 130, 132 can be deployed on an exterior of the structure 101 to provide the line of sight connection. In some embodiments, the vertical location anchors 130, 132 may be deployed within a building. For example, the vertical location anchors 130, 132 can be deployed within a courtyard of a building while still providing a line of sight connection to one or more location anchors above the ground level.

Once deployed and activated, the vertical location anchors 130, 132 may begin performing distance measurements with one or more of the location anchors 102, 104, 106. The distance measurements can be performed with RTLS ranging as described herein. Once the distance measurements are made, the distance measurements can be sent to the base station for further processing.

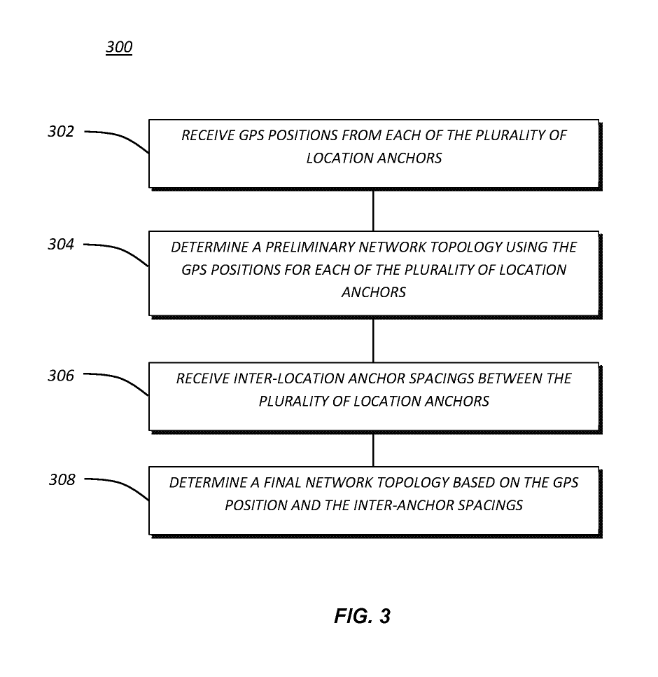

FIG. 3 illustrates a flowchart of a method 300 for establishing a location anchor network according to an embodiment. Once the location anchors 102, 104, 106 have been deployed and initiated, the GPS position estimates from each of the plurality of location anchors can be sent to and received by the base station at step 302. The location application 126 executing on the processor 122 at the base station 120 can receive the GPS estimates and determine a preliminary location network topology using the GPS positions for each of the plurality of location anchors 102, 104, 106 at step 304. In some embodiments, the preliminary location network topology can be used with the system to locate and track one or more tags 110 within the structure.

In an embodiment, the location network topology accuracy can be improved by using inter-location anchors data in addition to the GPS location information. In an embodiment, RTLS ranging using ultra-wide band signals to perform time of flight measurements can be used to determine the relative distance between pairs of the plurality of location anchors 102, 104, 106. The data for the inter-location anchor spacing between the plurality of location anchors can be received by the base station in step 306. The location application can then determine a final network topology using the inter-location anchors spacings to improve on the GPS location estimates in step 308.

The final location network topology can be stored in the memory 124 and generally defines a position estimate for each location anchor of the plurality of location anchors. The location network topology may also include information for the structure 101.

In some embodiments, the height information for the plurality of location anchors can be determined using one or more vertical location anchors 130, 132. In this embodiment, the distance measurements or information between one or more vertical location anchors 130, 132 and one or more of the location anchors 102, 104, 106 can be sent to the base station 120 and received by the location application 126. When a single distance measurement is made between a vertical location anchor 130 and a location anchor 102, 104, 106, the single measurement may be taken as the height of the plurality of location anchors. When distance measurements are available between a plurality of vertical location anchors 130, 132 and a location anchor, the location application 126 may use trilateration or multilateration to determine the distance between the ground level and the location anchor 102. The vertical height of the calculated triangle may be used as the vertical position of the plurality of location anchors.

The information from the preliminary topology and/or the final location network topology can be used to create a mapping of the structure 101 and the location anchors 102, 104, 106. When the vertical height information is available, the mapping can include the relative vertical position of the location anchors 102, 104, 106 above the ground level. The mapping can be displayed on a display 125 associated with the base station 120 and/or the mapping can be displayed on a display associated with the tag 110.

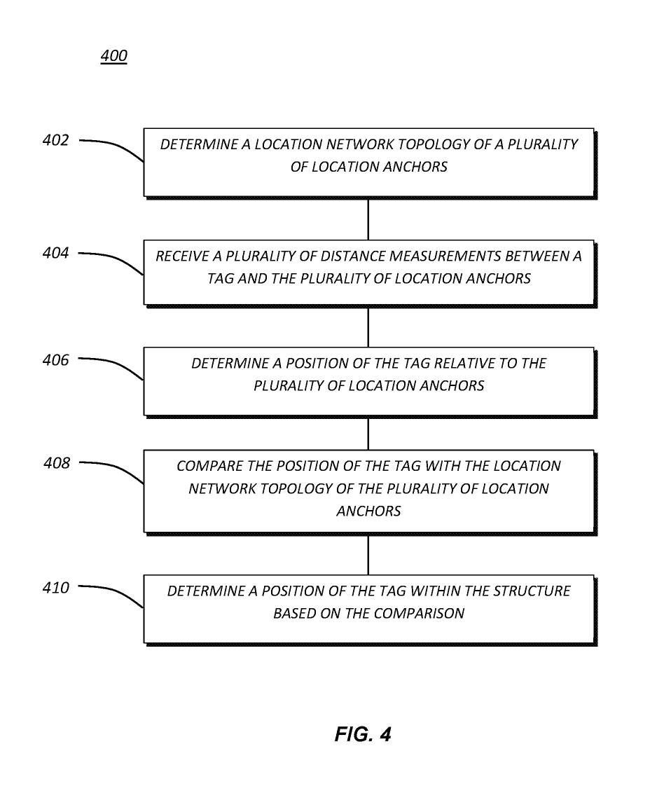

Once determined, the location network topology can be used to track one or more tags within the structure 101. FIG. 4 illustrates a flowchart of a method 400 of determining a location of a tag. The method 400 can begin with determining the location network topology of the plurality of location anchors deployed in a structure. While the location network topology can be determined using a variety of methods, the method 300 described herein can be used in an embodiment to determine the location network topology in step 402. The method 400 can then be used to track a tag 110 located within the structure 101 that is in signal communication with at least some of the plurality of location anchors 102, 104, 106.

In order to track the tag 110, a plurality of distance measurements between the tag 110 and the plurality of location anchors can be performed and sent to the base station 120 where the measurements can be received by the tracking application 128 in step 404. The distance measurements can be performed using the RTLS ranging system used to determine the distance between the location anchors 102, 104, 106. For example, ranging signals can be sent in one or two directions between the tag 110 and the corresponding location anchor. Based on the time of flight measurements, the distance between the tag 110 and the corresponding location anchor can be determined.

The tracking application 128 can determine a position of the tag 110 relative to the plurality of location anchors using the distance measurements in step 406. For example, three distance measurements can be used to determine the intersection of the three distances using the locations of the three location anchors. Such a trilateration process can be based on the distance measurements from three location anchors 102, 104, 106 to the tag 110. When more than three distance measurements are available, multilateration position determinations can be performed and an average used to determine a position. The relative error in each measurement may also be taken into account in using multiple location determinations to produce an estimated position with a reduced margin of error.

The position of the tag 110 can then be compared to the location network topology of the plurality of location anchors in the structure 101 in step 408. The tracking application 128 can be used to determine a relative position of the tag 110 with respect to the plurality of location anchors, which may result in a position estimation related to a geographic frame of reference and/or a position estimate with respect to the structure. In step 410, the position of the tag 110 within the structure can then be determined based on the comparison step 408.

When vertical height information of the location anchors is available, the height of the tag 110 can be determined by the tracking application 128. The tracking application may include an offset when the location anchors are not located on the same floor as the tag 110. Using an estimated height of each floor, the floor location of the tag 110 can be determined based on the height information. Special floor heights can be provided to the tracking application 128 for use in the floor determination. For example, a height of a first floor may be different than the height of the remaining floors. The first floor height can be provided to the tracking application 128 for use in the floor determination.

The tag 110 location determination can be performed manually, periodically, or aperiodically. For example, a manual determination can be initiated by the holder of the tag 110 and/or an operator of the base station 120. This may allow a location to be determined as needed. Alternatively, the location determination may be performed at periodic intervals such as every thirty seconds, every minute, every five minutes, etc. The use of a periodic interval may provide the ability to produce a smooth track of the tag within the structure 101. In some embodiments, the location determination may be performed aperiodically such as upon the occurrence of certain events. For example, the tag 110 location determination may be performed each time the holder of the tag 110 pushes a communication button to talk with the base station or other personnel. The distance information may then be transmitted over the same channel as the communications. As another example, a gas detector associated with the tag may trigger an alarm indicating an exposure above a threshold. The tag 110 location may be determined to ensure that the location of the tag holder is known when the exposure begins.

Each time the tag 110 location is determined, the method 400 may be repeated and a new location determined. The repetition of the tag location determination may allow a track of the tag 110 to be determined and stored in the memory 124. The track may provide a history of the location of the responder, which may allow the last known location of the tag to be quickly determined. In some embodiments, the tracking application 128 may provide a prediction of the current location of the tag 110 based on the track.

The mapping application 129 may accept information from the tracking application 128 and provide a display of the tag 110 location(s) and/or track(s) on the display. The display can include the model of the structure 101 as described above, and the location of the tag 110 relative to the structure can be displayed. When multiple tags are present, one or more of the tags can be displayed on the mapping at the same time.

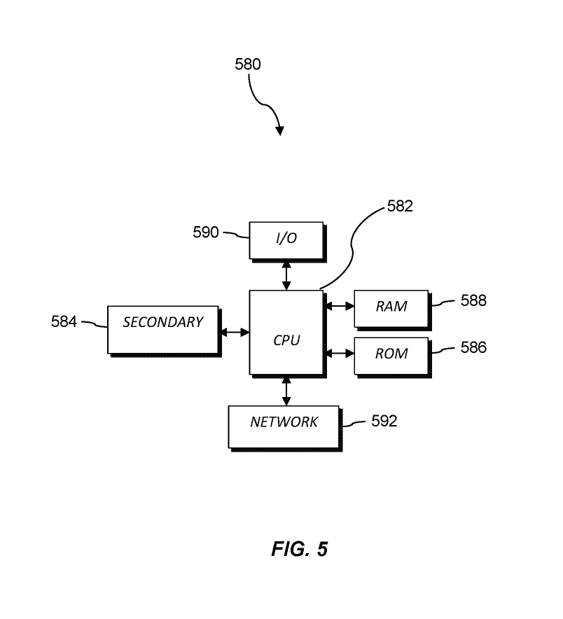

FIG. 5 illustrates a computer system 580 suitable for implementing one or more embodiments disclosed herein. For example, the computer system 580 may be used to implement any of the network components. The computer system 580 includes a processor 582 (which may be referred to as a central processor unit or CPU) that is in communication with memory devices including secondary storage 584, read only memory (ROM) 586, random access memory (RAM) 588, input/output (I/O) devices 590, and network connectivity devices 592. The processor 582 may be implemented as one or more CPU chips.

It is understood that by programming and/or loading executable instructions onto the computer system 580, at least one of the CPU 582, the RAM 588, and the ROM 586 are changed, transforming the computer system 580 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 580 is turned on or booted, the CPU 582 may execute a computer program or application. For example, the CPU 582 may execute software or firmware stored in the ROM 586 or stored in the RAM 588. In some cases, on boot and/or when the application is initiated, the CPU 582 may copy the application or portions of the application from the secondary storage 584 to the RAM 588 or to memory space within the CPU 582 itself, and the CPU 582 may then execute instructions that the application is comprised of In some cases, the CPU 582 may copy the application or portions of the application from memory accessed via the network connectivity devices 592 or via the I/O devices 590 to the RAM 588 or to memory space within the CPU 582, and the CPU 582 may then execute instructions that the application is comprised of. During execution, an application may load instructions into the CPU 582, for example load some of the instructions of the application into a cache of the CPU 582. In some contexts, an application that is executed may be said to configure the CPU 582 to do something, e.g., to configure the CPU 582 to perform the function or functions promoted by the subject application. When the CPU 582 is configured in this way by the application, the CPU 582 becomes a specific purpose computer or a specific purpose machine.

The secondary storage 584 is typically comprised of one or more disk drives or tape drives and is used for non-volatile storage of data and as an over-flow data storage device if RAM 588 is not large enough to hold all working data. Secondary storage 584 may be used to store programs which are loaded into RAM 588 when such programs are selected for execution. The ROM 586 is used to store instructions and perhaps data which are read during program execution. ROM 586 is a non-volatile memory device which typically has a small memory capacity relative to the larger memory capacity of secondary storage 584. The RAM 588 is used to store volatile data and perhaps to store instructions. Access to both ROM 586 and RAM 588 is typically faster than to secondary storage 584. The secondary storage 584, the RAM 588, and/or the ROM 586 may be referred to in some contexts as computer readable storage media and/or non-transitory computer readable media.

I/O devices 590 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 592 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 592 may enable the processor 582 to communicate with the Internet or one or more intranets. With such a network connection, it is contemplated that the processor 582 might receive information from the network, or might output information to the network in the course of performing the above-described method steps. Such information, which is often represented as a sequence of instructions to be executed using processor 582, may be received from and outputted to the network, for example, in the form of a computer data signal embodied in a carrier wave.

Such information, which may include data or instructions to be executed using processor 582 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 582 executes instructions, codes, computer programs, scripts which it accesses from hard disk, floppy disk, optical disk (these various disk based systems may all be considered secondary storage 584), flash drive, ROM 586, RAM 588, or the network connectivity devices 592. While only one processor 582 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 584, for example, hard drives, floppy disks, optical disks, and/or other device, the ROM 586, and/or the RAM 588 may be referred to in some contexts as non-transitory instructions and/or non-transitory information.

In an embodiment, the computer system 580 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 580 to provide the functionality of a number of servers that is not directly bound to the number of computers in the computer system 580. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 580, at least portions of the contents of the computer program product to the secondary storage 584, to the ROM 586, to the RAM 588, and/or to other non-volatile memory and volatile memory of the computer system 580. The processor 582 may process the executable instructions and/or data structures in part by directly accessing the computer program product, for example by reading from a CD-ROM disk inserted into a disk drive peripheral of the computer system 580. Alternatively, the processor 582 may process the executable instructions and/or data structures by remotely accessing the computer program product, for example by downloading the executable instructions and/or data structures from a remote server through the network connectivity devices 592. The computer program product may comprise instructions that promote the loading and/or copying of data, data structures, files, and/or executable instructions to the secondary storage 584, to the ROM 586, to the RAM 588, and/or to other non-volatile memory and volatile memory of the computer system 580.

In some contexts, the secondary storage 584, the ROM 586, and the RAM 588 may be referred to as a non-transitory computer readable medium or a computer readable storage media. A dynamic RAM embodiment of the RAM 588, likewise, may be referred to as a non-transitory computer readable medium in that while the dynamic RAM receives electrical power and is operated in accordance with its design, for example during a period of time during which the computer system 580 is turned on and operational, the dynamic RAM stores information that is written to it. Similarly, the processor 582 may comprise an internal RAM, an internal ROM, a cache memory, and/or other internal non-transitory storage blocks, sections, or components that may be referred to in some contexts as non-transitory computer readable media or computer readable storage media.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1-15. (canceled)

16. A method for establishing a location anchor network comprising:
receiving, by a location application executing on a processor, GPS positions from each of the plurality of location anchors, where the plurality of location anchors are portable, and wherein the plurality of location anchors are deployed at a location associated with a structure;
determining, by the location application, a preliminary network topology using the GPS positions for each of the plurality of location anchors;
receiving, by the location application, an inter-location anchor spacing between the plurality of location anchors;
determining, by the location application, a final network topology based on the GPS position and the inter-anchor spacing, wherein the final network topology defines a position estimate for each location anchor of the plurality of location anchors; and
storing the final network topology in a memory.

17. The method of claim 16, wherein the inter-location anchor spacing is determined using ultra-wide band ranging between each location anchor of the plurality of location anchors and at least one other location anchor of the plurality of location anchors.

18. The method of claim 16, further comprising:
receiving distance information between at least one location anchor of the plurality of location anchors and one or more vertical location anchors, wherein the vertical location anchors are placed at a ground level of the structure;
triangulating a height of the at least one location anchor from the distance information; and
determining a vertical position of the plurality of location anchors using the height.

19. The method of claim 16, wherein the location anchors are placed on windows associated with the structure.

20. The method of claim 16, wherein the location anchors are placed around a perimeter of an exterior of the structure.

21. The method of claim 16, further comprising:
creating, by the location application, a mapping of the location network topology within a model of the structure.

22. A method of determining a location of a tag comprising:
determining a location network topology of a plurality of location anchors deployed in a structure, wherein determining the location network topology is based on both GPS position estimates of the plurality of location anchors and Real Time Location System ranging estimates of inter-location anchors spacings between the plurality of location anchors;
receiving, by a tracking application executing on a processor, a plurality of distance measurements between a tag and the plurality of location anchors;
determining, by the tracking application, a position of the tag relative to the plurality of location anchors;
comparing, by the tracking application, the position of the tag with the location network topology of the plurality of location anchors in a structure; and
determining a position of the tag within the structure based on the comparing.

23. The method of claim 22, wherein the location network topology comprises height information derived from a height measurement between one or more of the plurality of location anchors and a ground level of the structure, and wherein the method further comprises:
determining, by the tracking application, a height of the tag with the structure based on the location network topology; and
determining a floor in the structure on which the tag is located based on the determined height.

24. The method of claim 22, further comprising:
storing the position of the tag within the structure in a memory;
repeating the method at a subsequent time;
determining a second position of the tag within the structure based on the repeating;
storing the second position in the memory; and
creating a track of the tag based on the position associated with a first time and the second position associated with the subsequent time.

25. The method of claim 22, further comprising:
generating a map comprising a model of the structure;
displaying the position of the tag within the map of the structure.

26. The method of claim 22, further comprising determining the plurality of distance measurements between the tag and the plurality of location anchors using Real Time Location System ranging.

27. The method of claim 22, further comprising:
deploying the plurality of location anchors in the structure;
obtaining the GPS position estimates for each of the plurality of location anchors after deploying the plurality of anchors; and
obtaining the inter-location anchor spacings after deploying the plurality of location anchors.

28. The method of claim 22, wherein the plurality of distance measurements between the tag and the plurality of location anchors are based on time of flight measurements between the tag and each of the corresponding plurality of location anchors.

29. A location determination system comprising:
a plurality of location anchors, wherein the plurality of location anchors each comprise a GPS receiver, and Real Time Location System (RTLS) ranging system, and wherein the plurality of location anchors are deployed in a network associated with a structure;
at least one tag moveably disposed within the perimeter;
a base station in signal communication with the plurality of location anchors and the at least one tag, where the base station comprises a memory and a processor, wherein an application is stored in the memory that configures the processor to:
receive GPS positions from each of the plurality of location anchors;
receive inter-anchor spacings between at least two of the plurality of location anchors using the RTLS ranging system;
determine a relative position of each location anchor of the plurality of location anchors based on the GPS position;
correct the relative position of each location anchor using the inter-anchor spacings;
determine a location network topology of the plurality of location anchors based on the correcting;
determine a distance between the tag and at least two location anchors of the plurality of location anchors; and
determine a position of the tag within the location network topology based on the distances between the tag and the at least two location anchors of the plurality of anchors.

30. The location tracking system of claim 29, wherein the application further configures the processor to:
determine a relationship between the location network topology and the structure; and
determine a position of the tag within the structure based on the relationship of the tag and the location network topology.

31. The location tracking system of claim 29, further comprising: one or more vertical location anchors, wherein the vertical location anchors are disposed on a ground level of the structure, and wherein the vertical location anchors comprise RTLS ranging systems.

32. The location tracking system of claim 29, wherein the plurality of location anchors are portable.

33. The location tracking system of claim 29, wherein the RTLS ranging system comprises an ultra wideband transceiver.

34. The location tracking system of claim 29, further comprising: creating a mapping of the location network topology ad the position of the tag; and displaying the mapping on an output screen.

35. The location tracking system of claim 29, wherein the at least one tag comprises a RTLS ranging system configured to perform ranging determinations with the plurality of location anchors.
